(19) United States
(12) Patent Application Publication
(10) Pub. No.: US 2026/0017856 A1
(43) Pub. Date: Jan. 15, 2026

(54) SYSTEMS AND METHODS FOR OUTPAINTING IMAGES FOR DISPLAY PANEL DEFECT IMAGE AUGMENTATION USING SELF-SUPERVISED LEARNING

(71) Applicant: Samsung Display Co., Ltd., Yongin-si (KR)

(72) Inventors: Zhihong Pan, San Jose, CA (US); Rahul Shenoy, San Jose, CA (US); Kaushik Balakrishnan, San Jose, CA (US); Janghwan Lee, Pleasanton, CA (US)

(21) Appl. No.: 18/930,781

(22) Filed: Oct. 29, 2024

Related U.S. Application Data
(60) Provisional application No. 63/669,602, filed on Jul. 10, 2024.

(51) Int. Cl. G06T 11/60; G06T 3/40; G06T 7/00

(52) U.S. Cl. CPC G06T 11/60; G06T 3/40; G06T 7/0002; G06T 2207/20132

(57) ABSTRACT

A method may include receiving, by a processor comprising an outpainting model, an input NG image, generating a first set of masks based on the input NG image, and applying the first set of masks to the input NG image to expand a size of the input NG image by outpainting a first region relative to the input NG image to generate an output NG image.

### CROSS-REFERENCE TO RELATED APPLICATION

This application claims the priority benefit under 35 U.S.C. § 119(e) of U.S. Provisional Patent Application No. 63/669,602, filed on July 10, 2024, the disclosure of which is incorporated by reference in its entirety as if fully set forth herein.

### FIELD

The present disclosure generally relates to improving artificial intelligence training for defect classification. More particularly, the subject matter disclosed herein relates to systems and methods for outpainting images for display panel defect image augmentation using self-supervised learning.

### SUMMARY

Production of electronic devices, for example, television and mobile display devices have grown rapidly over the recent years. To keep up with the mass production of such devices, there have been efforts to improve manufacturing techniques and efficiencies, for example, by detecting, classifying, and repairing defects in the circuitry when they are produced at the manufacturing line. Improved techniques leveraging artificial intelligence (AI) and machine learning (ML) in such processes in alignment with emerging Industry 4.0 / Smart Manufacturing paradigm are desired.

According to an embodiment of the present disclosure, a method may include receiving, by a processor including an outpainting model, an input NG image; generating, by the processor, a first set of masks based on the input NG image; and applying, by the processor, the first set of masks to the input NG image to expand a size of the input NG image by outpainting a first region relative to the input NG image to generate an output NG image.

The method may further include: generating, by the processor, a second set of masks based on the input NG image; and applying, by the processor, the second set of masks to the input NG image, the second set of masks outpainting a second region relative to the input NG image.

The first set of masks and the second set of masks may be a same size as the input NG image, and the output NG image may be larger than the input NG image.

The first region may correspond to non-corner regions of the output NG image and the second region corresponds to corner regions of the output NG image.

The method may further include: generating, by the processor, a third set of masks based on the input NG image; and applying, by the processor, the third set of masks to the input NG image, the third set of masks removing a defect from the output NG image to generate an output OK image.

The third set of masks may be a same size as the input NG image.

Each mask of the first set of masks, each mask of the second set of masks, and each mask of the third set of masks may include an excluded area at a center region of the mask corresponding to a defect area of the input NG image, wherein the excluded area is omitted from outpainting by the outpainting model.

The excluded area may include constant values.

The first set of masks, the second set of masks, and the third set of masks may be configured to be applied in any sequence.

The method may further include cropping the output NG image or the output OK image.

According to another embodiment of the present disclosure, a system may include: a processor including an outpainting model; and a memory storing instructions executed by the processor to cause the processor to: receive an input NG image; generate a first set of masks based on the input NG image; and apply the first set of masks to the input NG image to expand a size of the input NG image by outpainting a first region relative to the input NG image to generate an output NG image.

The instructions may further cause the processor to: generate a second set of masks based on the input NG image; and apply the second set of masks to the input NG image, the second set of masks outpainting a second region relative to the input NG image.

The first set of masks and the second set of masks may be a same size as the input NG image, and the output NG image may be larger than the input NG image.

The first region may correspond to non-corner regions of the output NG image and the second region corresponds to corner regions of the output NG image.

The instructions may further cause the processor to: generate a third set of masks based on the input NG image; and apply the third set of masks to the input NG image, the third set of masks removing a defect from the output NG image to generate an output OK image.

The third set of masks may be a same size as the input NG image.

Each mask of the first set of masks, each mask of the second set of masks, and each mask of the third set of masks may include an excluded area at a center region of the mask corresponding to a defect area of the input NG image, wherein the excluded area is omitted from outpainting by the outpainting model.

The excluded area may include constant values.

The first set of masks, the second set of masks, and the third set of masks may be configured to be applied in any sequence.

The instructions may further cause the processor to crop the output NG image or the output OK image.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

In the following section, the aspects of the subject matter disclosed herein will be described with reference to exemplary embodiments illustrated in the figures, in which:

FIG. 1 is block diagram of a factory that produces, for example, electronic devices, such as organic light-emitting diode (OLED) devices, according to one or more embodiments of the present disclosure.

FIG. 2A is an example defect-free image of a source, FIG. 2B is an example defect image of the source, FIG. 2C is an example defect-free image of target, and FIG. 2D is an example defect image of the target, according to one or more embodiments of the present disclosure.

FIG. 3A is an example of an input defect (NG) image; FIGS. 3B-3C are examples of an output defect (NG) or defect free (OK) images outpainted according to one or more embodiments of the present disclosure.

FIG. 4 illustrates an outpainting model, configured to take an input image and output an output image, according to one or more embodiments of the present disclosure.

FIG. 5 illustrate example masks that may be utilized by the outpainting model to generate an output image, according to one or more embodiments of the present disclosure.

FIGS. 6A-6D illustrate the steps of outpainting an input image, according to one or more embodiments of the present disclosure.

FIG. 7 illustrate example masks that may be utilized by the outpainting model to further generate an output image, according to one or more embodiments of the present disclosure.

FIGS. 8A-8D illustrate the steps of the outpainting process, according to one or more embodiments of the present disclosure.

FIG. 9 illustrate example masks that may be utilized by the outpainting model to further generate and output image, according to one or more embodiments of the present disclosure.

FIG. 10A-10D illustrate the steps of the outpainting process, according to one or more embodiments of the present disclosure.

FIG. 11 is a flow chart of a method for outpainting an input image using an outpainting model to generate and output image, according to one or more embodiments of the present disclosure.

FIG. 12 is a block diagram of an electronic device in a network environment, according to according to one or more embodiments of the present disclosure.

Embodiments of the present disclosure and their advantages are best understood by referring to the detailed description that follows. Unless otherwise noted, like reference numerals denote like elements throughout the attached drawings and the written description, and thus, descriptions thereof will not be repeated. In the drawings, the relative sizes of elements, layers, and regions may be exaggerated for clarity.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures(including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

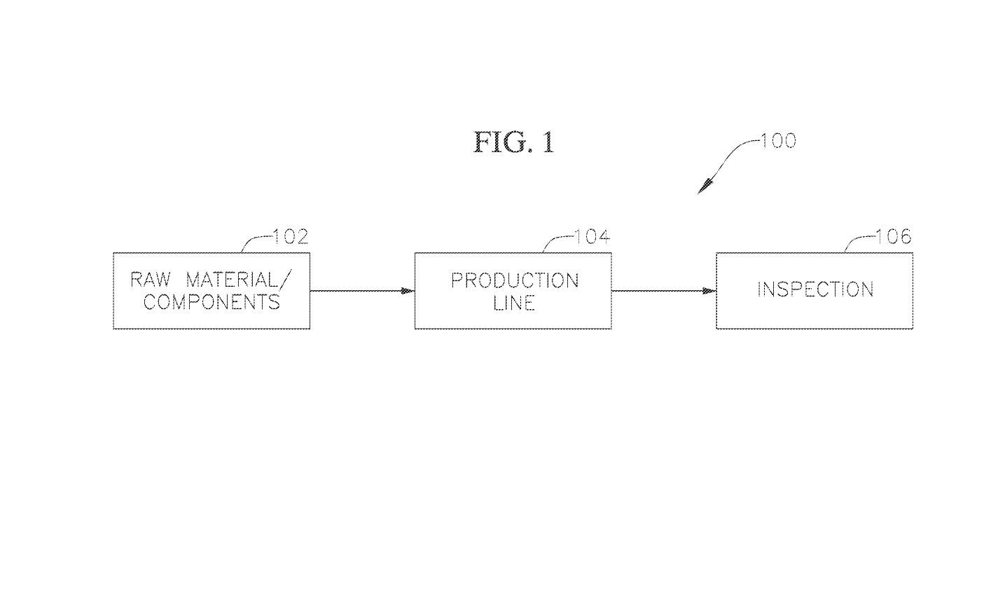

Manufacturing of products in a factory or a production line may include various processes to ensure certain quality requirements are satisfied. FIG. 1 is block diagram of a factory that produces, for example, electronic devices, such as organic light-emitting diode (OLED) devices. The production line 104 may be a system of machines, machinery, or devices, that take raw materials and/or components 102 as inputs and assembles, constructs, or produces one or more products such as the OLED devices. At the output of the production line 104, an inspection 106 system or mechanism may be implemented to conduct quality assurance by looking for defects in the product or portions of the products (e.g., in the circuitry) to classify the defects, and in some instances even repair the defects.

It is desirable to identify defects in the Mobile Display OLED manufacturing process with high accuracy for efficiency and robustness. In some systems, much of the defect identification, classification, and repair process may be undertaken by human personnel in a Remote Operator System (ROS) who remotely operate the auto repair process. However, this approach may be relatively costly as it involves a large number of human operators in the defect identification and defect repair stages. This process may also be relatively time consuming and prone to human error, which makes the overall system inefficient. To make the manufacturing process more robust, an artificial intelligence (AI)-based defect classification and repair system may be utilized according to some embodiments. However, to build an AI-based classifier, it may be desirable to have data balance between the number of defect-free (OK) and defect (NG) sample images used to train the AI model. This, however, may be difficult because the number of defect samples in manufacturing are typically a very small subset of the total (e.g., 1-2% of the total), and therefore may hinder the development of a robust defect detection classifier.

An AI-based generative model may be utilized to overcome this problem. The AI generative model may learn the data distribution of defect-free (OK) and defect (NG) samples from source products and transfer them to OK images from target products to create synthetic NG images for the target products. Throughout the present disclosure, the terms “defect-free image” and “OK image” may be used interchangeably and are intended to have the same meaning. The terms “defect image” and “NG image” may be used interchangeably and are intended to have the same meaning. Herein the present disclosure, the term “source” or “source products” may refer to those products that have been in mass production for a reasonably long time (e.g., more than one year) such that a large corpus of manufacturing defect images is available. On the other hand, the term “target” or “target products” may refer to those products that are relatively newer, for example, those that were introduced in the factory relatively recently and therefore many defect images are not available. Thus, the lack of many defect images may hinder the development of classifiers for the auto repair system, and therefore, it is desired for an AI-based generative model to learn the defect distribution from the source products, and then transfer the defects from source products to target products, thereby creating fake (or synthetic) defect images for the target products.

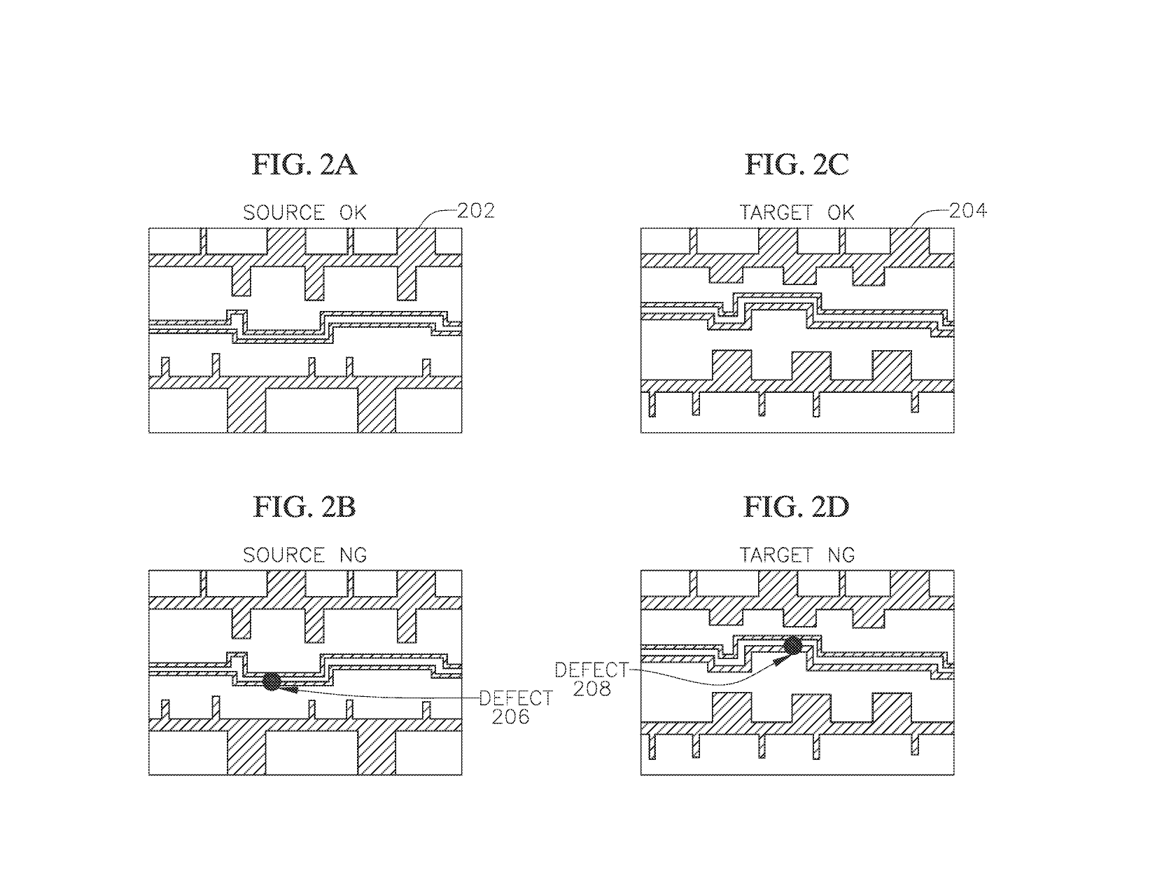

FIG. 2A is an example defect-free image of a source, FIG. 2B is an example defect image of the source because there is a defect 206 present in the image, FIG. 2C is an example defect-free image of target, and FIG. 2D is an example defect image of the target because there is a defect 208 present in the image. Herein the present disclosure, a defect may refer to some type of abnormality in the product or device that is captured in an image by the inspection system. The defect may result from the production line, for example, malfunctioning during the manufacturing process. Therefore, in the case of an electronic device or circuitry, the defect may include, for example, a short circuit or open circuit in the wiring or traces on a circuit board. Accordingly, FIG. 2A shows a close-up view of a portion of an example circuit board illustrating traces 202 of a source product or device that is defect free. Similarly, FIG. 2C shows a close-up view of a portion of an example circuit board illustrating traces 204 of a target product or device that is defect free. Thus, although the target circuit board is not an identical circuit board as the source, there are some similarities between the source and the target. The terms “product” and “device” may be used interchangeably in the present disclosure.

Therefore, according to some embodiments, from a system perspective, a generative-AI system may be used to take a defect image from the source and generate a synthetic defect image on the target. This process may be used to generate a sufficient amount of defect images so that an AI-classifier for the target product may be trained so that it can classify images and automatically repair any defects. Accordingly, a neural network of the diffusion model may be trained from the source device such that the trained neural network can be used to take OK images of the target device and generate synthetic defect (NG) images of the target device. In other words, the defect image of the source product such as that shown in FIG. 2B may be used to train the neural network such that this neural network may be used on the target product to generate a synthetic defect image of the target product such as that shown in FIG. 2D. Therefore, even though the image of the target product did not have a defect (as shown in FIG. 2C), a “fake” defect 208 may be generated on the image of the target product as shown in FIG. 2D.

To further increase or maximize the defect transfer capability, NG images from all source and target products may be mixed as one NG class to train the diffusion model, which is conditional to class-label (OK or NG). To synthesize a target NG image, a target OK image may be injected with noise and the diffusion model may be applied with a NG-condition to convert it to target NG images. The NG class label may be an explicit condition to ensure defect generation, and the target OK image may be an implicit condition as the diffusion model relies on its noisy version to preserve the target image background. The OK image may require the injected noise to be lower than the level for full potential of diffusion model generation capability. Alternatively, the diffusion model may also be trained as conditional to OK image in addition to class label, thus the injected noise level is not limited.

In either case, there may be challenges in practices to assemble an optimal training set, particularly with the NG images. For source products, the NG images may be collected in the past and they may be limited in size and resolution which may make data augmentation such as random scaling and cropping of the images limited. In the other case of a diffusion model conditional to OK image, while it may be desired for better defect generation capability, paired OK and NG images which both share the same background may be useful for training. However, such paired images may not exist in practice. Therefore, techniques to increase the number of training images from the source is desired. One or more embodiments of the present disclosure describe an outpainting model using self-supervised learning to improve data augmentation in multiple ways: 1) generate realistic OK content which extend beyond the extent (e.g., size) of a given NG image; and 2) remove defect and restore OK pattern of a given NG image. In the first case, a larger size NG image is generated so random scaling and cropping augmentation is possible. For the second case, paired OK and NG images are generated so diffusion models that are conditional to OK images may be trained. Furthermore, as there are often domain gaps between OK and NG images such as different color and/or resolution, or in some cases OK images may be missing, the outpainting model according to one or more embodiments may be trained using only the NG images, and thereby being self-supervised learning.

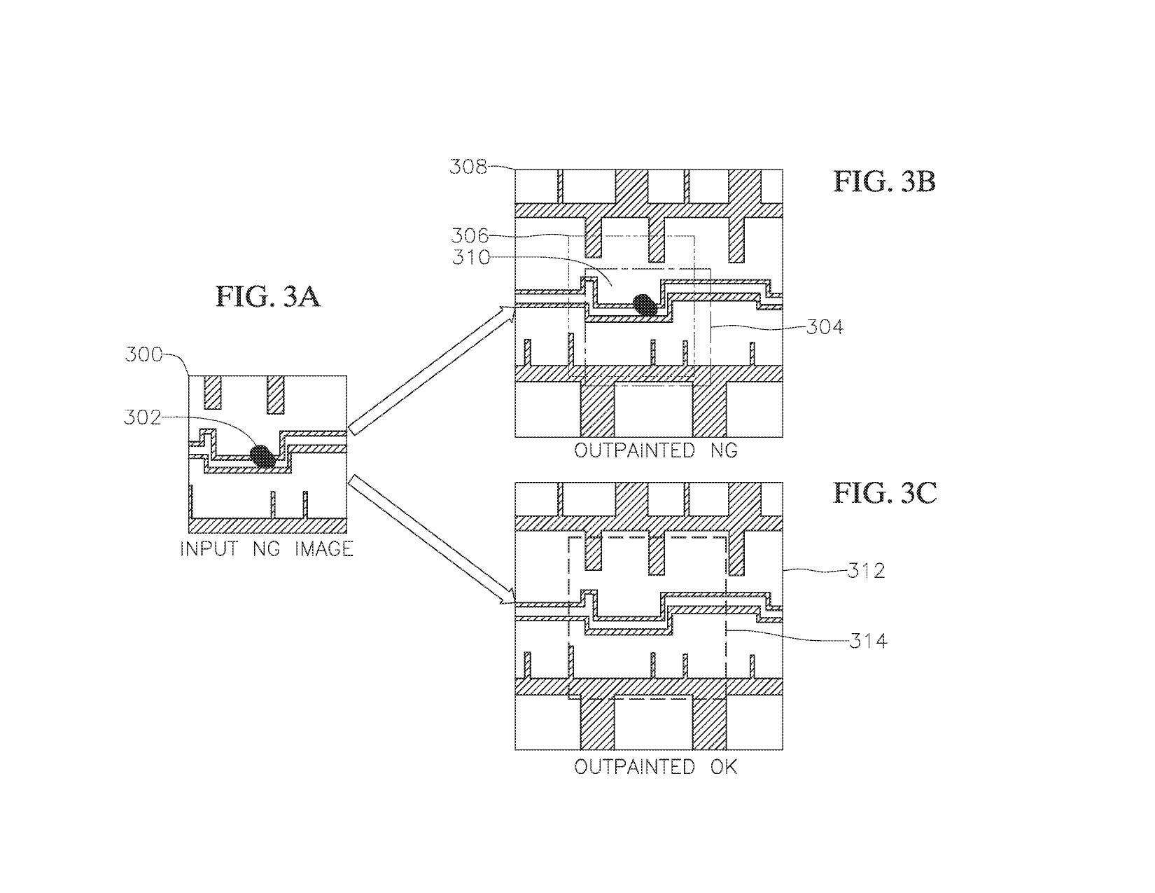

FIG. 3A is an example of an input defect image. FIG. 3B is an example of an output defect image outpainted according to one or more embodiments of the present disclosure. FIG. 3C is an example output defect free image outpainted according to one or more embodiments of the present disclosure. It should be noted that these input images are obtained from a source product and the outpainting model may be configured to generate an outpainted output image of the source product such as the ones shown in FIG. 3B and FIG. 3C.

Referring to FIG. 3A, a defect image of a source product is captured as an input image 300. The image shows a background pattern of the image with the defect shown with a black dot 302. To augment the input image 300, the input image may be outpainted by extending the pattern beyond the boundaries of the input image 300 (which is a smaller image) so that an output image 308 (which is a larger image) may be generated as shown in FIG. 3B and FIG. 3C. Once the larger image 308 is generated, a different defect image 310 may be augmented (e.g., generated) from the outpainted image by cropping the output image in various manner. For example, the outpainted image may be cropped, for example, along the dashed lines 304 or along the dash-dotted lines 306. Therefore, the larger outpainted output image 308 may be cropped and resized to the size of the input image but the image may be slightly different than the input image because the cropped frame is different from the input image 300. In some embodiments, the cropped image may even be smaller than the input image size. Accordingly, defect images of different sizes and/or shapes may be cropped to generate additional variations in training data. By doing so, a variety of defect images that were previously not present may be generated to train the AI generative model. Because having a variety of augmented OK images and NG images is desired, augmented NG images such as the one is FIG. 3B may be generated and augmented OK images such as the one in FIG. 3C may be generated.

In one or more embodiments, the defect may be removed in the outpainted model by repainting the input image 300 and extending the background pattern so that the generated output image 312 is a larger defect free image as shown in FIG. 3C. Because the outpainted output image 312 is now a larger image, it may be cropped back to a smaller image (e.g., the same size at the input image), for example, along dotted lines 314 in various manners similarly to the outpainted defect image 308. Furthermore, by cropping the outpainted defect free image 312, a paired OK-NG image dataset may be generated wherein one image of the pair is a defect free image and the other image of the pair is a defect image, thus being an OK-NG image pair, which may be used as further variations in training data.

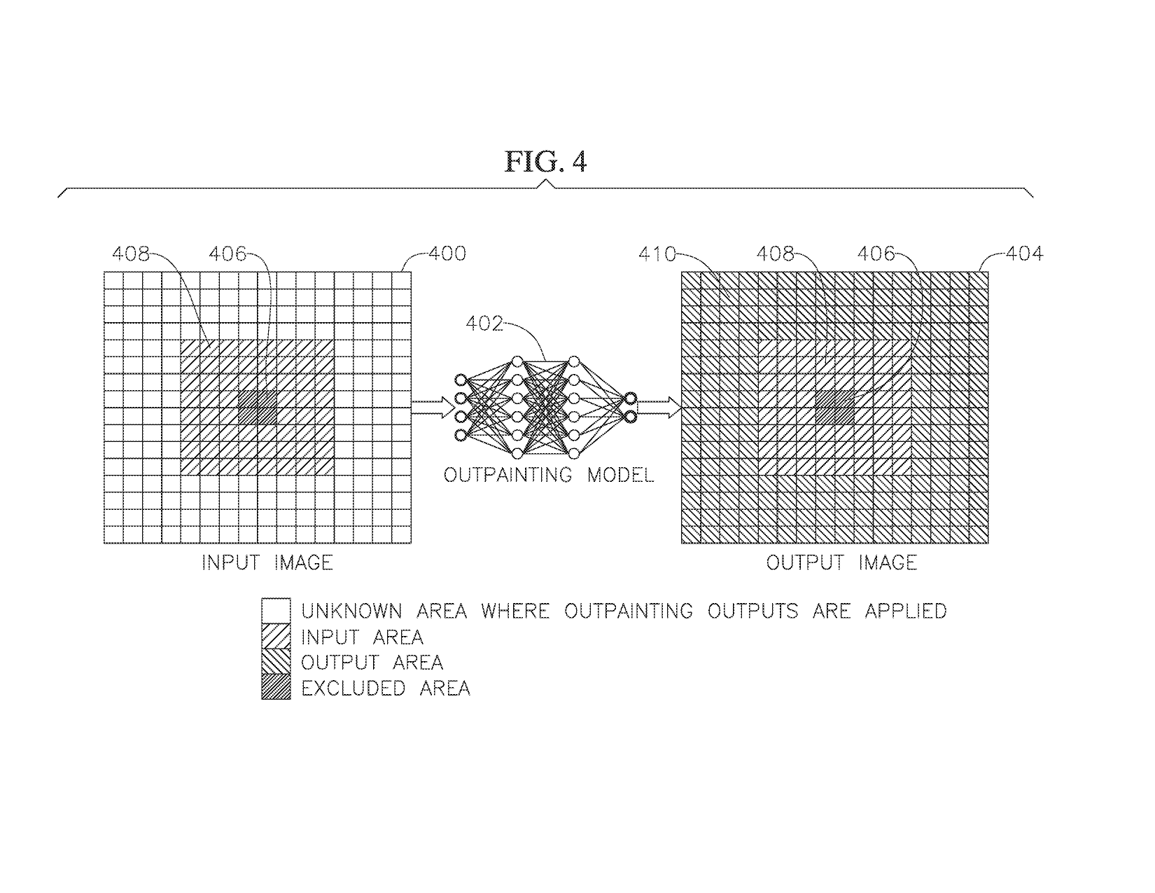

FIG. 4 illustrates an outpainting model, according to one or more embodiments of the present disclosure. The outpainting model 402 may be a generative AI model that takes an input image 400 and generates an outpainted output image 404. Here, the input image 400 may include an excluded area 406 and an input area 408. For example, the input image 400 may be a defect image and therefore the excluded area 406 may correspond to the defect area of the input image 400. The input area 408 may correspond to portions of the input image 400 that does not have a defect, for example, the background image. The area surrounding the input area 408 is the area that does not have an image (e.g., unknown area) and therefore it is desired to expand the image to this area by outpainting an image using the outpainting model 402, according to one or more embodiments of the present disclosure.

The output image 404 may include the excluded area 406, the input area 408, and an output area 410. The excluded area 406 of the output image 404 may correspond to the defect area, and the input area 408 may correspond to the area of the image that was provided (or carried over) from the input image 400. The output area 410 of the output image 404 may correspond to the area that was outpainted by the outpainting model 402. In other words, the portion of the image that was expanded (or generated) from the outpainting may be referred to as the output area 410. Thus, the outpainting model 402 may outpaint the output area 410 to generate an output image 404 that is larger than the input image 400. According to one or more embodiments, the outpainting model 402 may be utilized to achieve at least two objectives, for example, generating realistic OK content which extend beyond the extent (e.g., size or boundaries) of a given NG image so that a different image may be cropped, and removing a defect from the image so that an OK-NG image pair may be generated. Because the defect may be removed, a defect free image may also be generated, and this image may be paired with the defect image to provide a pair of images made up of an OK image and an NG image, thus providing an OK-NG image pair. The outpainting model 402 may achieve these objectives by utilizing the known area of the input image, referred to as the input area 408 to generate contents in the output area 410, including both outside and inside of the input range.

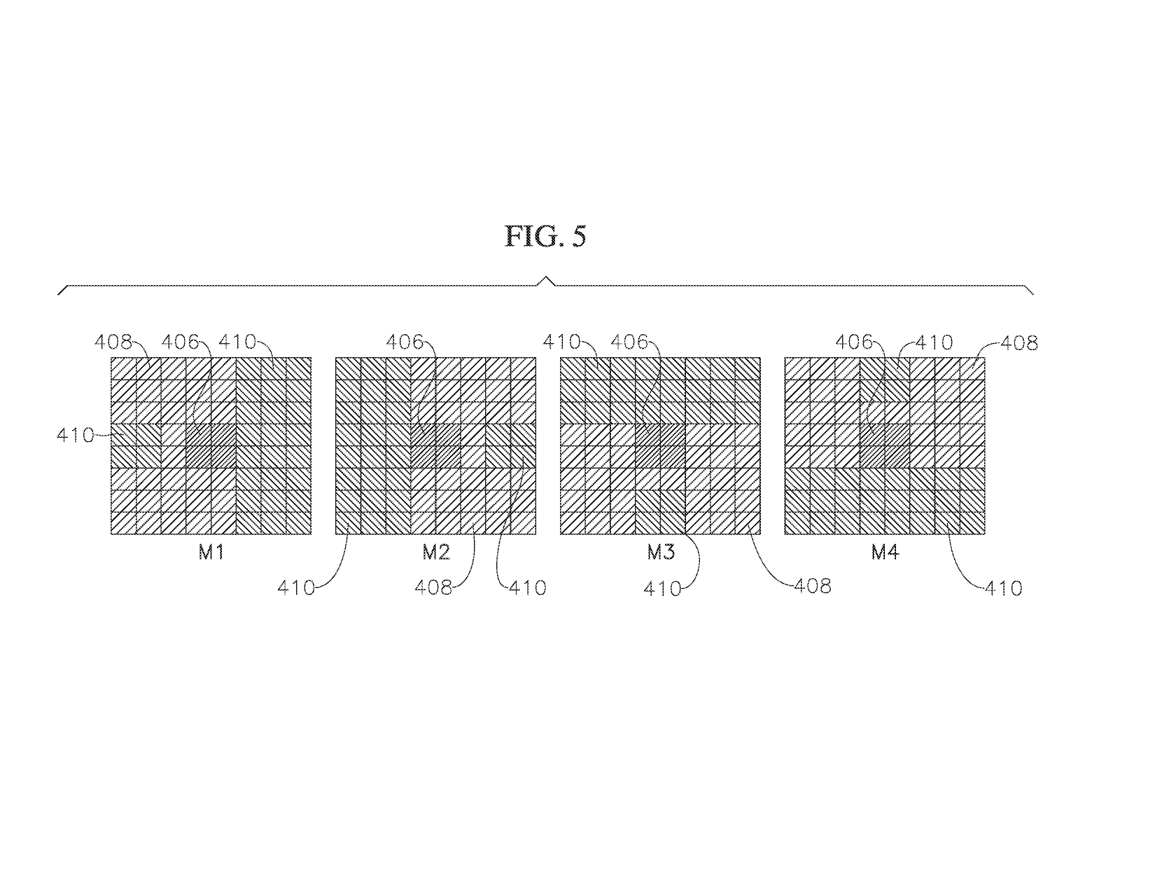

Because the output image 404 is formed by expanding the boundaries of the input image 400, the output image 404 is larger than the input image 400. The excluded area 406 may correspond to the area where the defect is located on the image so during the outpainting process, this portion may be replaced with constant values so that it does not interfere with the outpainting process. In other words, it is not desired to carry over the defect information so the defect portion may be replaced with constant values. Based on this framework, unknown areas of the output image 404 (e.g., the areas beyond the boundaries of the input image 400) may be filled with outputs values from the outpainting model 402, but in the input areas 408, the original values from the input images 400 may be preserved and reused or it may be replaced with outputs from the outpainting model 402, or a combination thereof. For the excluded area 406, pixel values from the original input image may be restored. This framework will be explained in more detail with reference to FIG. 5.

FIG. 5 illustrates example masks that may be utilized by the outpainting model 402 to expand the input image 400 to a larger output image 404 by expanding or extending the image to one direction at a time. These masks are the same size as input NG images, therefore, self-supervised learning may be performed from the input NG images. For example, each mask may include an excluded area 406, an input area 408, and an output area 410. Each of these masks may be applied to an input image to gradually extend the size of the image. For example, a first mask M1 may be the same size as the input image in that the image size is an 8x8 pixel and the first mask M1 is also an 8x8 pixel. It should be noted that the pixel sizes are provided here to for the purpose of explaining the concepts related to the mask and the images, and therefore are merely examples and is not intended to be limiting. Instead, the mask and/or images may be include any number of pixels (e.g., 256 x 256, in which case each square illustrated in FIG. 5 may correspond to 32 pixels, or 1024 x 1024, in which case each square illustrated in FIG. 5 may correspond to 128 pixels). The first mask M1 includes an excluded area 406 at the center of the image and the right side of the mask corresponds to an output area 410. In some embodiments, a portion (output area 410) of the image on the left side also corresponds to an output area 410 as shown in mask M1. The remaining portions of mask M1 is an input area 408. Similarly, mask M2 may include an excluded area 406 at the center of the image, but differently from mask M1, the output area 410 is along the left side of the mask M2, and a small portion of the right side (output area 410) of the image may also include an output area 410. Mask M3 may be similar to masks M1 and M2 with the excluded area 406 at the center, except the input area 408 is along the top of the mask and the bottom portion may also include a small output area 410. Mask M4 includes the output area 410 along the bottom of the image and a small output 410 area at the top of the mask. All remaining portions may be input areas 408. According to one or more embodiments, the outpainting model may apply masks M1-M4 to expand the input image 400 to generate the outpainted output image 404.

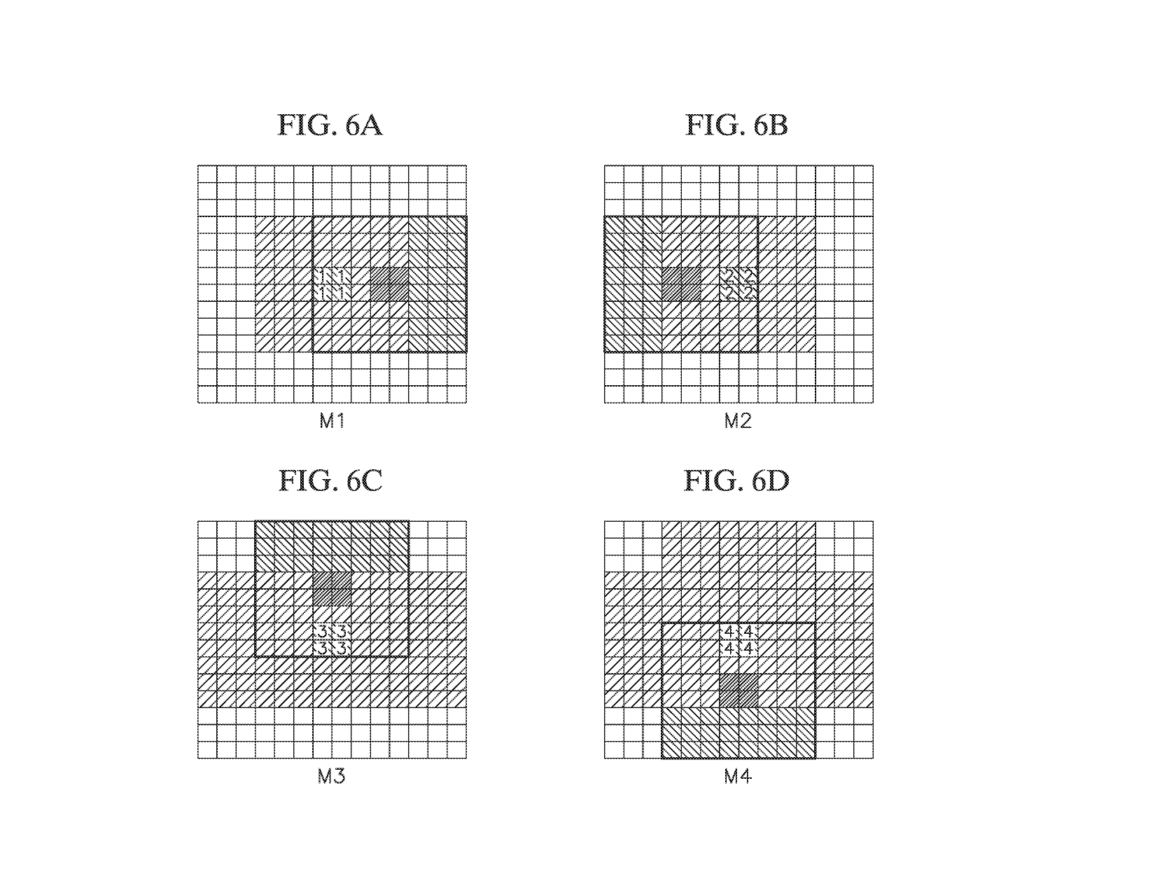

FIGS. 6A-6D illustrate the steps of outpainting an input image 400 to extend beyond the boundaries of the input image by using outpainting masks M1-M4, according to one or more embodiments of the present disclosure. The input image 400 may correspond to the input image 400 shown in FIG. 4, and the outpainting model 402 may apply a plurality of masks to outpaint an output image 404. For example, referring to FIG. 6A, an input image 400 is initially provided with defect in the middle of the input image 400. When mask M1 is applied to the input image 400, the output area 410 of mask M1 replaces the defect and expands the image to the right, beyond the right boundary of the input image 400. Continuing on with the outpainting process, a second mask M2 may be applied to the input image 400 as shown in FIG. 6B, thereby extending the original input image 400 to the left by the output area 410 of mask M2. The output area 410 from mask M2 may also replace the defect of the input image 400 but in this case, mask M1 has already replaced the defect. Similarly, a third mask M3 may be applied as shown in FIG. 6C, which extends the input image 400 in the upward direction, and a fourth mask M4 may be applied as shown in FIG. 6D, thereby extending the input image 400 downward toward the bottom. Accordingly, by applying first through fourth masks M1-M4, the smaller input image may be extended in all directions thereby outpainting the original image to a larger image. However, as shown in FIG. 6D after the first four masks are applied, the corners of the image are still missing, i.e., are not yet outpainted. Therefore, another set of masks may be applied to complete the outpainting process.

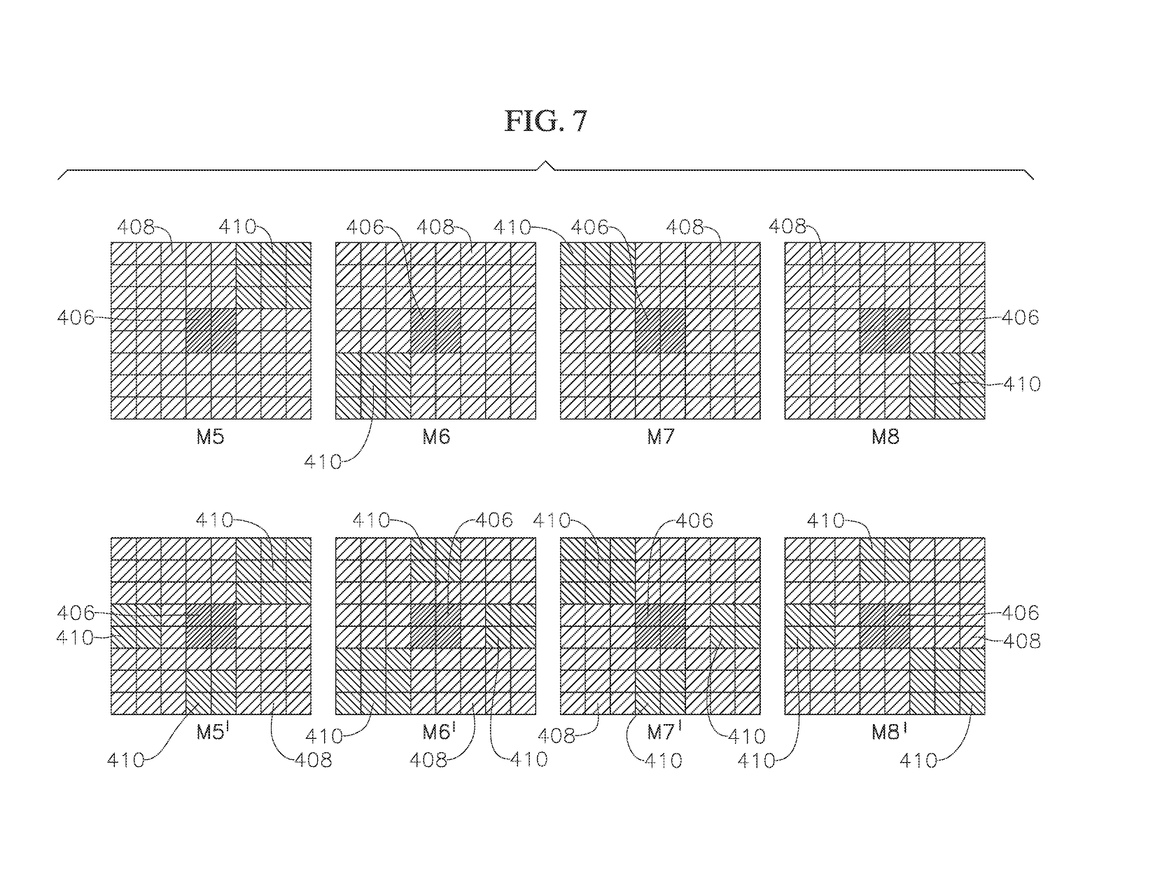

FIG. 7 shows masks M5-M8, which may be used by the outpainting model 402 in addition to masks M1-M4 to fill the missing corners, according to one or more embodiments of the present disclosure. Similar to masks M1-M4, masks M5-M8 also include an excluded area 406, input area 408, and output area 410. Because masks M5-M8 are intended to fill the missing corners, the output area 410 of mask M5 is at the upper right corner, the output area 410 of mask M6 is at the lower left corner, the output area 410 of mask M7 is at the upper left corner, and the output area 410 of mask M8 is at the lower right corner. Thus, when masks M5-M8 are outpainted by the outpainting model 402, the corners of the outpainted output image 404 may be outpainted (e.g., filled in).

In some embodiments, alternative masks M5’-M8’ may be utilized instead of masks M5-M8. Masks M5’-M8’ may be similar to masks M5-M8 in that they are intended to outpaint the corners. However, masks M5’-M8’ include additional output areas 410 that may be outpainted as shown in FIG. 7. For example, if the defect area of the input image 400 is larger, the additional output area 410 of mask M5’-M8’ may help to replace the larger defect areas.

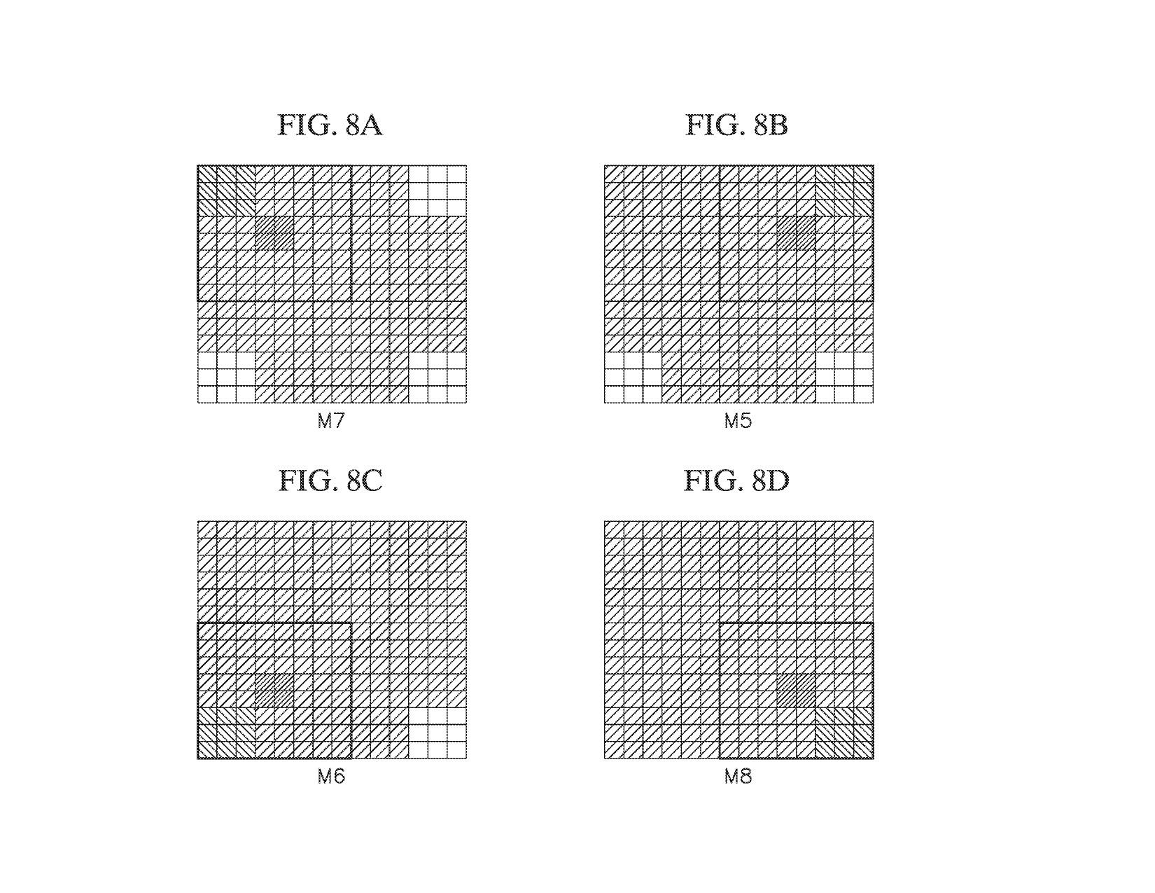

FIGS. 8A-8D illustrate the steps of continuing with the outpainting process of the input image 400 from FIGS. 6A-6D, to fill in the corners that were not outpainted by masks M1-M4, according to one or more embodiments of the present disclosure. The input image 400 may correspond to the input image 400 shown in FIG. 4. As can be seen in FIG. 6D, after the input image 400 is outpainted with masks M1-M4, the corners of the output image 400 remain unfilled. FIG. 8A illustrates the outpainted output image 404 from FIG. 6D being further outpainted using mask M7 to fill the upper left corner. Similarly, in FIG. 8B, mask M5 may be utilized to outpaint the upper right corner. In FIG. 8C, mask M6 may be utilized to outpaint the lower left corner, and in FIG. 8D, mask M8 may be utilized to outpaint the lower right corner. Accordingly, after masks M1-M8 have been applied, a complete output image 404 (e.g., an image that is larger than the input image) may be generated. Although the outpainting processes illustrated in FIGS. 6A-6D and FIGS. 8A-8D show the masks being applied in a particular order, the masks may instead be applied in any order and the same or substantially similar output image 404 may be generated. Accordingly, a completed outpainted output image 404 may look like the image shown in FIG. 3B if the defect is kept (e.g., NG image) or FIG. 3C if the defect is removed (e.g., OK image).

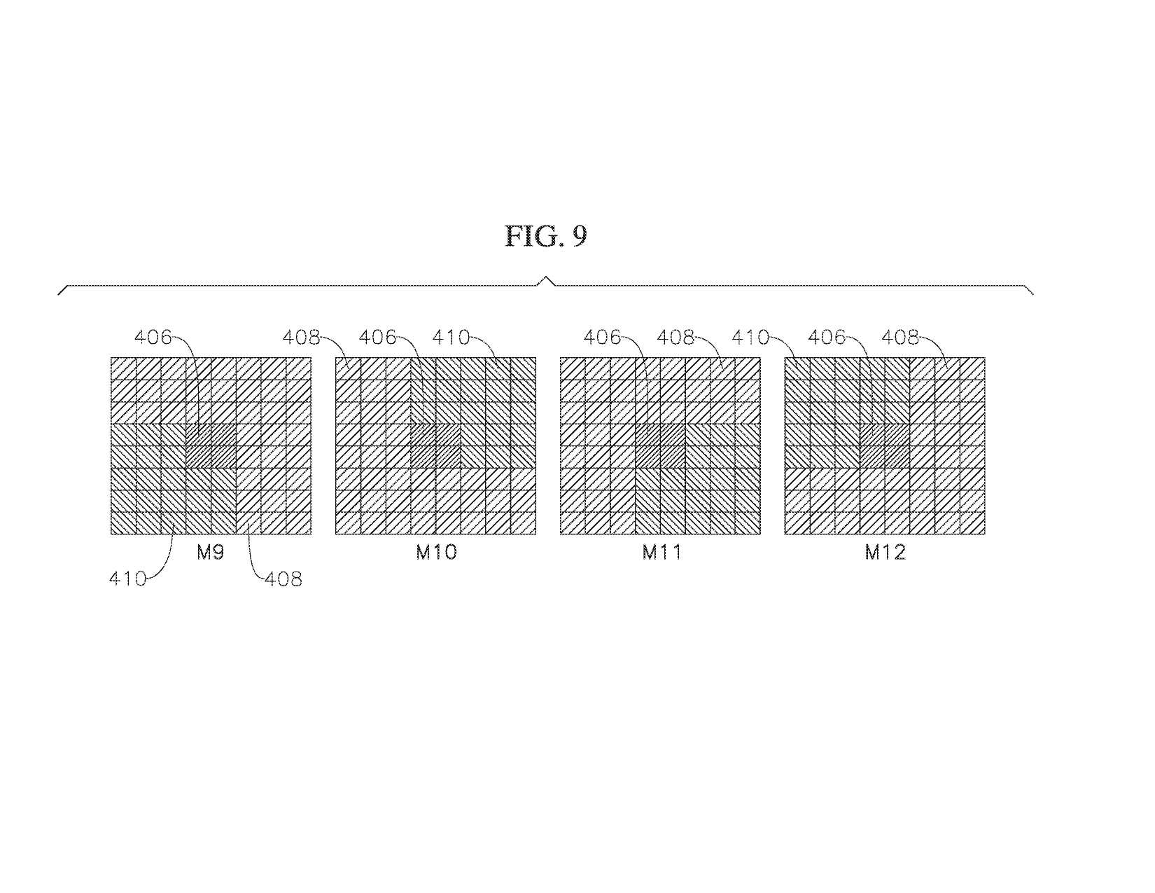

FIG. 9 illustrate masks M9-M12 which may be utilized by the outpainting model 402 to repaint the input area to improve NG to OK conversion for larger defects, according to one or more embodiments of the present disclosure. For example, when masks M1-M4 are used to outpaint the input image 400, masks M1-M4 have an output area that may be used to repaint the defect area as shown in FIGS. 6A-6D. However, if the defect is larger, the repainted area may not sufficiently cover the entire defect. Thus, masks M9-M12 having a larger output area 410 than masks M1-M4 may be applied to further repaint the input image 400 and improve removing the defect area to convert from an NG image to an OK image.

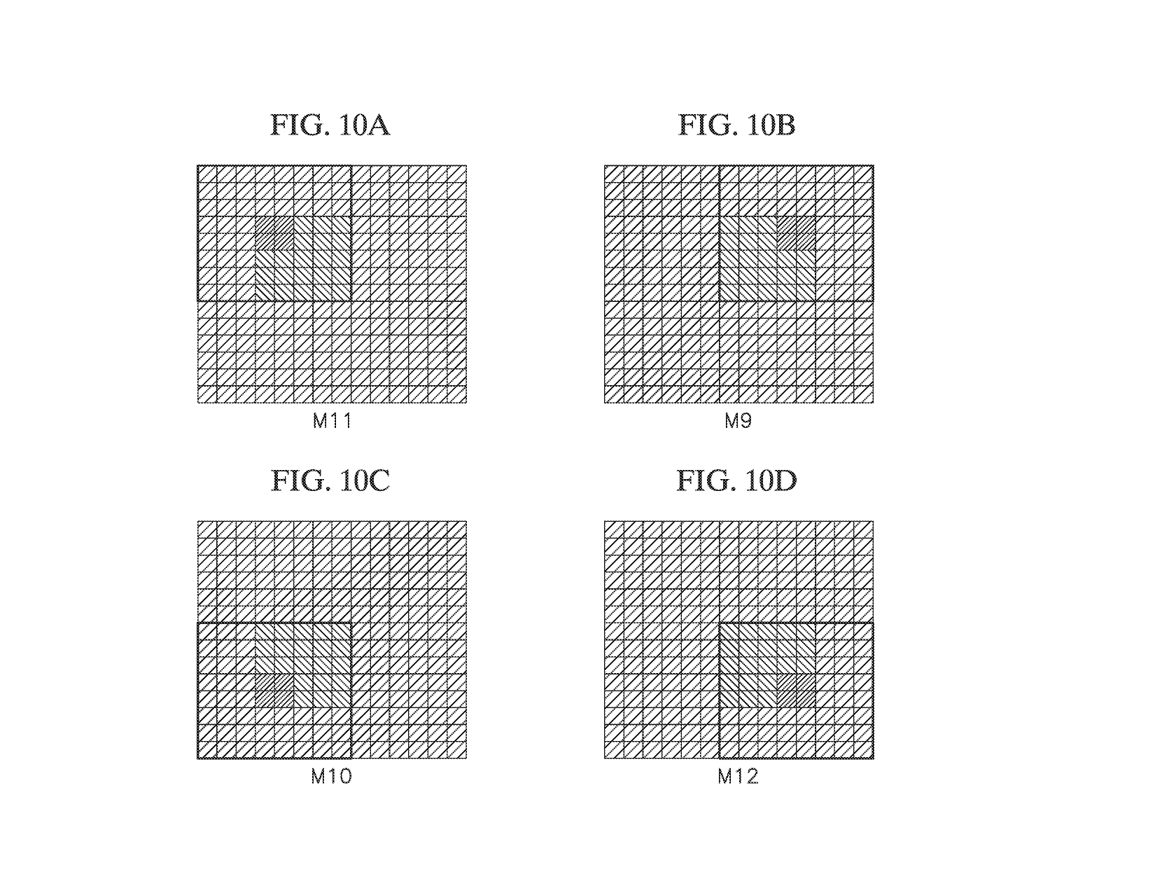

FIG. 10A-10D illustrate masks M9-M12 being utilized by the outpainting model 402 to repaint the defect area. For example, in FIG. 10A, mask M11 is applied to the upper left corner and the output area 410 of mask M11 overlaps a portion of the defect area. That is, while the output area 410 of mask M11 may not necessarily overlap the entirety of the defect area, it covers at least an upper left portion of the defect area. In FIG. 10B, mask M9 may be applied to the upper right corner such that the output area 410 of mask M9 overlaps another portion (e.g., the upper right portion) of the defect area. Similarly, in FIG. 10C, mask M10 may be applied to the lower left corner such that the output area 410 of mask M10 overlaps a lower left portion of the defect area and in FIG. 10D, mask M12 may be applied to the lower right corner such that the output area 410 of mask M12 overlaps a lower right portion of the defect area. Accordingly, with each of masks M9-M12 covering a different portion of the defect area, a larger area of the defect area may be covered compared to masks M1-M4 and therefore improving the repainting of the defect area and conversion from NG image to OK image.

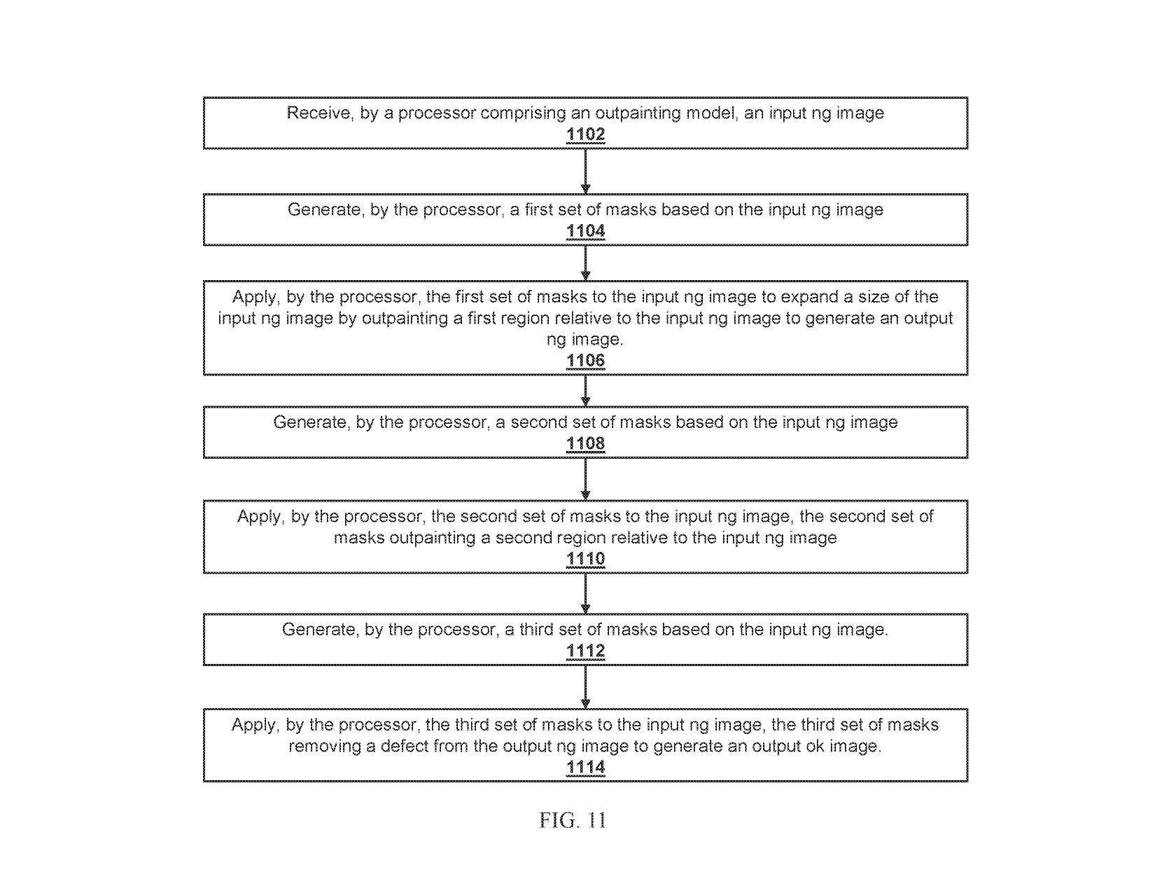

FIG. 11 is a flow chart of a method for outpainting an input image using an outpainting model to generate an output image, according to one or more embodiments of the present disclosure. Although FIG. 11 illustrates various operations in a method for outpainting an input image using and outpainting model to generate an output image, embodiments according to the present disclosure are not limited thereto, and according to some embodiments, the number or order of operations may vary. For example, some embodiments may include additional operations or fewer operations, or the order of operations may vary, unless otherwise stated or implied, without departing from the spirit and scope of embodiments according to the present disclosure.

A processor including an outpainting model, may receive an input defect (NG) image (operation 1102). For example, the input NG image may be a real image captured from a source product from a manufacturing facility. The processor may then generate a first set of masks based on the input NG image (operation 1104). For example, the first set of masks may include masks M1-M4 shown in FIG. 5, wherein each of the masks may be generated using the information captured in the input NG image. An area corresponding to the location of the defect in the input NG image may be an excluded area so that that portion of the mask is not utilized for outpainting. Next, the processor may apply the first set of masks to the input NG image to expand a size of the input NG image by outpainting a first region relative to the input NG image to generate an output NG image (operation 1106). For example, each mask of the first set of masks may expand the input NG image in one direction so that four masks may expand the input NG image in four different directions. Thus, the first region may correspond to each of the regions in which the input NG image is expanded, e.g., in an outward direction from the center.

In some embodiments, the processor may generate a second set of masks based on the input NG image (operation 1108). This process may be similar to generating the first set of masks but the pattern of the masks may be configured to expand the input NG image to a different region. Accordingly, the processor may apply the second set of masks to the input NG image, such that the second set of masks outpaints a second region different from the first region relative to the input NG image (operation 1110). For example, the outpainting in the first region by the first set of masks may not outpaint the corner regions of the output image. Therefore, the second set of masks may be used to outpaint the second region, which may correspond to the corners of the output image. By way of example, the second set of masks may correspond to masks M5-M8 or masks M5’-M8’ shown in FIG. 7. By applying the first set of masks and the second set of masks, the input NG image may be expanded.

In some embodiments, the processor may generate a third set of masks based on the input NG image (operation 1112). In some instances, the defect of the NG image may be larger. In such case, the output areas of the masks of the first and/or second set of masks may not sufficiently cover the defect area. Therefore, the third set of masks may be configured to more completely repaint over the relatively larger defect area of input NG image. Accordingly, the processor may apply the third set of masks to the input NG image to effectively remove the defect from the output NG image, and thereby generating an output defect-free (OK) image (operation 1114). By way of example, the third set of masks may correspond to masks M9-M12 shown in FIG. 9. However, it should be noted that the masks illustrated throughout the present disclosure are intended to be examples, and therefore other masks or patterns of masks may be utilized instead on in addition to those shown. Furthermore, the application of the masks may be performed in various orders. For example, the second set of masks may be applied first, followed by the first set of masks. In other embodiments, the third set of masks may be applied first and the remaining masks may be applied thereafter.

Accordingly, the above-described techniques may be utilized to generated additional NG images and OK images by outpainting available input NG images. That is, such NG and OK images may be generated without having to rely on OK images but instead relying only on available NG images. Once the additional NG and OK images are generated through such self-supervised learning, these images may be cropped to different size images and/or the OK and NG images may be paired up to generated paired OK-NG images. Accordingly, such augmented images may be utilized as additional training images to train a generative AI classifier that may be used to in a production line for another product (e.g., a target product), which may ultimately be used to detect, identify, remove, and/or fix defective components, portions of components, and/or products. More particularly, the factory may produce one or more electronic devices such as, for example, a display device, a smartphone, an OLED/QD-LED display, and the like, which may include corresponding circuitry (e.g., microchips with circuitry that are produced by semiconductor fabrication processes).

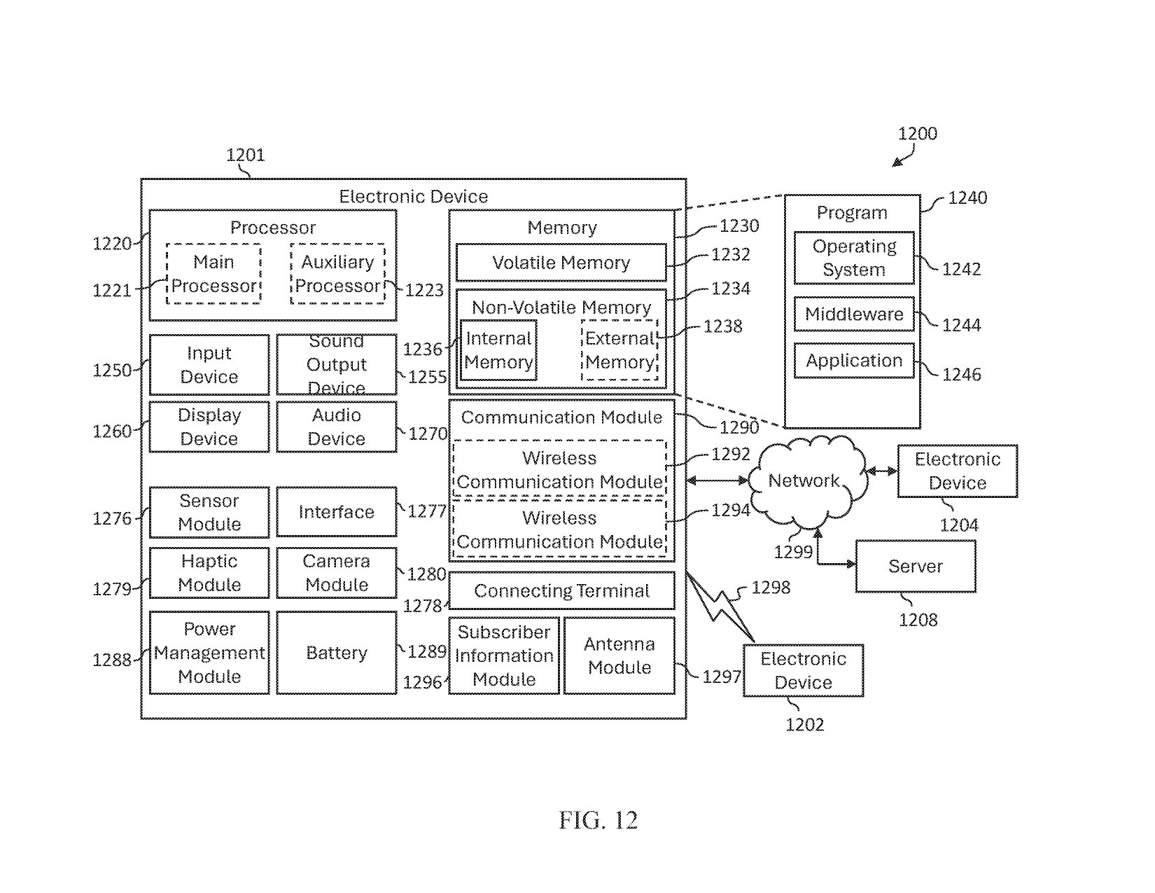

FIG. 12 is a block diagram of an electronic device in a network environment 1200, that may be configured to include the outpainting model including a neural network, according to an embodiment.

Referring to FIG. 12, an electronic device 1201 in a network environment 1200 may communicate with an electronic device 1202 via a first network 1298 (e.g., a short-range wireless communication network), or an electronic device 1204 or a server 1208 via a second network 1299 (e.g., a long-range wireless communication network). The electronic device 1201 may communicate with the electronic device 1204 via the server 1208. The electronic device 1201 may include a processor 1220, a memory 1230, an input device 1250, a sound output device 1255, a display device 1260, an audio module 1270, a sensor module 1276, an interface 1277, a haptic module 1279, a camera module 1280, a power management module 1288, a battery 1289, a communication module 1290, a subscriber identification module (SIM) card 1296, or an antenna module 1297. In one embodiment, at least one (e.g., the display device 1260 or the camera module 1280) of the components may be omitted from the electronic device 1201, or one or more other components may be added to the electronic device 1201. Some of the components may be implemented as a single integrated circuit (IC). For example, the sensor module 1276 (e.g., a fingerprint sensor, an iris sensor, or an illuminance sensor) may be embedded in the display device 1260 (e.g., a display).

The processor 1220 may execute software (e.g., a program 1240) to control at least one other component (e.g., a hardware or a software component) of the electronic device 1201 coupled with the processor 1220 and may perform various data processing or computations.

As at least part of the data processing or computations, the processor 1220 may load a command or data received from another component (e.g., the sensor module 1276 or the communication module 1290) in volatile memory 1232, process the command or the data stored in the volatile memory 1232, and store resulting data in non-volatile memory 1234. The processor 1220 may include a main processor 1221 (e.g., a central processing unit (CPU) or an application processor (AP)), and an auxiliary processor 1223 (e.g., a graphics processing unit (GPU), an image signal processor (ISP), a sensor hub processor, or a communication processor (CP)) that is operable independently from, or in conjunction with, the main processor 1221. Additionally or alternatively, the auxiliary processor 1223 may be adapted to consume less power than the main processor 1221, or execute a particular function. The auxiliary processor 1223 may be implemented as being separate from, or a part of, the main processor 1221.

The auxiliary processor 1223 may control at least some of the functions or states related to at least one component (e.g., the display device 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). The auxiliary processor 1223 (e.g., an image signal processor or a communication processor) may be implemented as part of another component (e.g., the camera module 1280 or the communication module 1290) functionally related to the auxiliary processor 1223.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234. Non-volatile memory 1234 may include internal memory 1236 and/or external memory 1238.

The program 1240 may be stored in the memory 1230 as software, and may include, for example, an operating system (OS) 1242, middleware 1244, or an application 1246.

The input device 1250 may receive a command or data to be used by another component (e.g., the processor 1220) of the electronic device 1201, from the outside (e.g., a user) of the electronic device 1201. The input device 1250 may include, for example, a microphone, a mouse, or a keyboard.

The sound output device 1255 may output sound signals to the outside of the electronic device 1201. The sound output device 1255 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1260 may visually provide information to the outside (e.g., a user) of the electronic device 1201. The display device 1260 may include, for example, a display, a hologram device, or a projector and control circuitry to control a corresponding one of the display, hologram device, and projector. The display device 1260 may include touch circuitry adapted to detect a touch, or sensor circuitry (e.g., a pressure sensor) adapted to measure the intensity of force incurred by the touch.

The audio module 1270 may convert a sound into an electrical signal and vice versa. The audio module 1270 may obtain the sound via the input device 1250 or output the sound via the sound output device 1255 or a headphone of an external electronic device 1202 directly (e.g., wired) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. The sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device 1202 directly (e.g., wired) or wirelessly. The interface 1277 may include, for example, a high- definition multimedia interface (HDMI), a universal serial bus (USB) interface, a secure digital (SD) card interface, or an audio interface.

A connecting terminal 1278 may include a connector via which the electronic device 1201 may be physically connected with the external electronic device 1202. The connecting terminal 1278 may include, for example, an HDMI connector, a USB connector, an SD card connector, or an audio connector (e.g., a headphone connector).

The haptic module 1279 may convert an electrical signal into a mechanical stimulus (e.g., a vibration or a movement) or an electrical stimulus which may be recognized by a user via tactile sensation or kinesthetic sensation. The haptic module 1279 may include, for example, a motor, a piezoelectric element, or an electrical stimulator.

The camera module 1280 may capture a still image or moving images. The camera module 1280 may include one or more lenses, image sensors, image signal processors, or flashes. The power management module 1288 may manage power supplied to the electronic device 1201. The power management module 1288 may be implemented as at least part of, for example, a power management integrated circuit (PMIC).

The battery 1289 may supply power to at least one component of the electronic device 1201. The battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the AP) and supports a direct (e.g., wired) communication or a wireless communication. The communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as BLUETOOTH^{TM}, wireless-fidelity (Wi-Fi) direct, or a standard of the Infrared Data Association (IrDA)) or the second network 1299 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The antenna module 1297 may transmit or receive a signal or power to or from the outside (e.g., the external electronic device) of the electronic device 1201. The antenna module 1297 may include one or more antennas, and, therefrom, at least one antenna appropriate for a communication scheme used in the communication network, such as the first network 1298 or the second network 1299, may be selected, for example, by the communication module 1290 (e.g., the wireless communication module 1292). The signal or the power may then be transmitted or received between the communication module 1290 and the external electronic device via the selected at least one antenna.

Commands or data may be transmitted or received between the electronic device 1201 and the external electronic device 1204 via the server 1208 coupled with the second network 1299. Each of the electronic devices 1202 and 1204 may be a device of a same type as, or a different type, from the electronic device 1201. All or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1201. The electronic device 1201 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
receiving, by a processor comprising an outpainting model, an input NG image;
generating, by the processor, a first set of masks based on the input NG image; and
applying, by the processor, the first set of masks to the input NG image to expand a size of the input NG image by outpainting a first region relative to the input NG image to generate an output NG image.

2. The method of claim 1, further comprising:
generating, by the processor, a second set of masks based on the input NG image; and
applying, by the processor, the second set of masks to the input NG image, the second set of masks outpainting a second region relative to the input NG image.

3. The method of claim 2,
wherein the first set of masks and the second set of masks are a same size as the input NG image, and
wherein the output NG image is larger than the input NG image.

4. The method of claim 3, wherein the first region corresponds to non-corner regions of the output NG image and the second region corresponds to corner regions of the output NG image.

5. The method of claim 3, further comprising:
generating, by the processor, a third set of masks based on the input NG image; and
applying, by the processor, the third set of masks to the input NG image, the third set of masks removing a defect from the output NG image to generate an output OK image.

6. The method of claim 5, wherein the third set of masks is a same size as the input NG image.

7. The method of claim 6, wherein each mask of the first set of masks, each mask of the second set of masks, and each mask of the third set of masks comprises an excluded area at a center region of the mask corresponding to a defect area of the input NG image, wherein the excluded area is omitted from outpainting by the outpainting model.

8. The method of claim 7, wherein the excluded area comprises constant values.

9. The method of claim 7, wherein the first set of masks, the second set of masks, and the third set of masks are configured to be applied in any sequence.

10. The method of claim 7, further comprising cropping the output NG image or the output OK image.

11. A system comprising:
a processor comprising an outpainting model; and
a memory storing instructions executed by the processor to cause the processor to:
receive an input NG image;
generate a first set of masks based on the input NG image; and
apply the first set of masks to the input NG image to expand a size of the input NG image by outpainting a first region relative to the input NG image to generate an output NG image.

12. The system of claim 11, wherein the instructions further cause the processor to:
generate a second set of masks based on the input NG image; and
apply the second set of masks to the input NG image, the second set of masks outpainting a second region relative to the input NG image.

13. The system of claim 12, wherein the first set of masks and the second set of masks are a same size as the input NG image, and
wherein the output NG image is larger than the input NG image.

14. The system of claim 13, wherein the first region corresponds to non-corner regions of the output NG image and the second region corresponds to corner regions of the output NG image.

15. The system of claim 13, wherein the instructions further cause the processor to: generate a third set of masks based on the input NG image; and
apply the third set of masks to the input NG image, the third set of masks removing a defect from the output NG image to generate an output OK image.

16. The system of claim 15, wherein the third set of masks is a same size as the input NG image.

17. The system of claim 16, wherein each mask of the first set of masks, each mask of the second set of masks, and each mask of the third set of masks comprises an excluded area at a center region of the mask corresponding to a defect area of the input NG image, wherein the excluded area is omitted from outpainting by the outpainting model.

18. The system of claim 17, wherein the excluded area comprises constant values.

19. The system of claim 17, wherein the first set of masks, the second set of masks, and the third set of masks are configured to be applied in any sequence.

20. The system of claim 17, wherein the instructions further cause the processor to crop the output NG image or the output OK image.
